(19) United States
(12) Patent Application Publication
(10) Pub. No.: US 2002/0143720 A1
(43) Pub. Date: Oct. 3, 2002

(54) Data structure for improved software implementation of a neural network

(76) Inventors: Robert Lee Anderson, Saline, MI (US); Scott Graham Miller, Ypsilanti, MI (US)

Correspondence Address: QUARLES & BRADY LLP, 411 E. WISCONSIN AVENUE, SUITE 2040, MILWAUKEE, WI, 53202-4497, US

(21) Appl. No.: 09/825,049

(22) Filed: Apr. 3, 2001

(51) Int. Cl. G06F 15/18

(52) U.S. Cl. 706/26

(57) ABSTRACT

A data structure for processing a neural network, and a method of processing a neural network are disclosed. The data structure, which is in a memory device, includes a first data structure portion and a second data structure portion within the memory device. The first data structure portion includes a first plurality of sequential memory locations. Each of the first plurality of sequential memory locations stores a respective input data signal value to be provided to respective inputs of both a first neuron and a second neuron of a first layer of the neural network. The second data structure portion includes a second plurality of sequential memory locations. Each of the second plurality of sequential memory locations stores a respective weight value corresponding to a respective input of a respective one of the first neuron and the second neuron.

### FIELD OF THE INVENTION

The present invention relates to neural network computer architectures and, in particular, to the software implementation of neural networks.

### BACKGROUND OF THE INVENTION

Neural networks are computing devices inspired by biological models and distinguished from other computing devices by an architecture which employs a number of highly interconnected elemental “neurons”. Each neuron is comprised of a summing junction for receiving weighted input data signals, which are the “inputs” of the neuron. The weighted input data signals are provided by weighting various input data signals being provided to the neurons with weighting values that typically vary depending upon the input data signal. The summing junction adds the weighted input data signals together and is ordinarily followed by a compressor or “squashing” function (typically a sigmoid function or logistic curve), that compresses the output from the summing junction into a predetermined range, ordinarily from zero to one. The neuron's output, termed a result or activation, is the output from the compressor. The input data signals that are weighted and then provided to each neuron can be connected to the outputs of many other neurons and the neuron's result can be provided, in turn, as the input data signals for still other neurons.

In a “feedforward” neural net architecture, inputs to the neural network are received as the input data signals for a first layer of neurons, the results of which serve as the input data signals for a second layer of neurons and so on for as many layers as desired. The final layer provides the final result or output of the network. In a “recursive” neural network architecture, at least some of the results of a particular layer of neurons are fed back as input data signals to that same layer in order to produce new results during a “propagation.” Both types of neural network architectures are realizable through programs running on conventional von Neuman architecture digital computers, or constructed with dedicated analog or digital circuitry (for example, using analog summing junctions and function generators to construct each neuron). In operation, the neural network receives an input or a set of inputs and produces an output or set of outputs dependant upon the inputs and upon the weighting values assigned with respect to the input data signals that are provided to each neuron. With the appropriate selection of the weighting values, a variety of computational processes can be performed.

With respect to neural networks generally, including both feedforward and recursive neural networks, the amount of information that must be stored and retrieved during operation of a neural network rapidly becomes large as the number of layers of neurons, the number of neurons in the various layers, the number of input data signals being provided to the different neurons, and the number of weighting values increases. Consequently, neural networks typically require a large amount of memory. In addition, the time associated with the storing and retrieving of information in and from the memory also can be large and be a limiting factor in the design and operation of neural networks.

It therefore would be desirable if a new system and method for storing neural network information were developed that reduced the amount of memory required by neural networks. It would further be desirable if this new system and method made it possible to store and retrieve information to and from memory at a faster rate than in conventional systems. It would additionally be desirable if this new system and method were simple and inexpensive to implement.

### SUMMARY OF THE INVENTION

The present inventors have recognized that a new data structure can be developed that reduces the amount of memory that is needed to store the information required for performing the processing of a neural network. Additionally, the new data structure reduces the amount of time that is needed to store and retrieve information to and from memory in performing the processing of the neural network. The new data structure includes a first data structure portion and a second data structure portion. The new data structure takes advantage of the typical structure of neural networks, in which the neurons of each particular layer are provided with the same input data signals. Because of the repetition of input data signals for multiple neurons of particular layers of neurons, the first data structure portion is able to store a single respective set of input data signals for all of the neurons of a respective layer of neurons. The input data signals of each set corresponding to a particular layer of neurons are stored in sequential memory locations, and the sets of input data signals for the different layers of neurons are also stored in sequential groupings of memory locations.

The second data structure portion is used to store the weight values corresponding to each input data signal being provided to each neuron of the neural network, and the weight values for the neural network are also stored in sequential memory locations. By storing the input signals for each given layer of neurons only once, the first data structure portion reduces the amount of memory required for implementing the neural network. Additionally, by sequentially storing the input data signals for each given layer, sequentially storing the sets of input data signals in accordance with the layers of the neural network, and sequentially storing the weight values corresponding to the different input data signals being provided to each of the different neurons, both the storage and retrieval of information to and from memory can be performed at a rapid pace during processing of the neural network. The new data structure makes it possible in one embodiment to employ a looped calculation program to process the neural network, where the looped calculation program utilizes pointers to access the different sequential memory locations containing the different input data signals and weight values.

In particular, the present invention relates to a data structure for processing a neural network in a memory device. The data structure includes a first data structure portion and a second data structure portion within the memory device. The first data structure portion includes a first plurality of sequential memory locations, wherein each of the first plurality of sequential memory locations stores a respective input data signal value to be provided to respective inputs of both a first neuron and a second neuron of a first layer of the neural network. The second data structure portion includes a second plurality of sequential memory locations, wherein each of the second plurality of sequential memory locations stores a respective weight value corresponding to a respective input of a respective one of the first neuron and the second neuron. The processing of the neural network includes sequentially retrieving the respective weight values corresponding to the respective inputs of the first neuron from the second plurality of sequential memory locations, sequentially retrieving each of the input data signal values corresponding to the respective inputs of the first neuron from the first plurality of sequential memory locations, and weighting each of the input data signal values with the corresponding respective weight value for the respective input of the first neuron, in order to calculate a first result of the first neuron. The processing of the neural network further includes sequentially retrieving the respective weight values corresponding to the respective inputs of the second neuron from the second plurality of sequential memory locations, sequentially retrieving each of the input data signal values corresponding to the respective inputs of the second neuron from the first plurality of sequential memory locations, and weighting each of the input data signal values with the corresponding respective weight value for the respective input of the second neuron, in order to calculate a second result of the second neuron.

The present invention further relates to a neural net processing device. The neural net processing device includes a first storage means for storing in a first set of sequential locations and a second set of sequential locations, respectively, a first set of weighting values that correspond to respective inputs of a first neuron, and a second set of weighting values that correspond to respective inputs of a second neuron. The neural net processing device additionally includes a second storage means for storing in a third set of sequential locations a set of input data signal values corresponding to respective inputs of both the first neuron and the second neuron. The neural net processing device further includes a neural net processor that sequentially accesses pairs of input data signal values from the third set of sequential locations and corresponding weighting values from the first set of sequential locations for respective inputs of the first neuron, weights the input data signal values with the corresponding weighting values from the first set of sequential locations, and sums the weighted input data signal values in calculating a first result for the first neuron. The neural net processor additionally sequentially accesses pairs of input data signal values from the third set of sequential locations and corresponding weighting values from the second set of sequential locations for respective inputs of the second neuron, weights the input data signal values with the corresponding weighting values from the second set of sequential locations, and sums the weighted input data signal values in calculating a second result for the first neuron.

The present invention additionally relates to a method of processing a neural network. The method includes (a) accessing, through the use of a first pointer, a weighting value corresponding to an input of a first neuron of a first layer, the weighting value being stored at a first memory location in a first data structure portion that corresponds to a first value of the first pointer, and (b) accessing, through the use of a second pointer, an input data signal value corresponding to the input of the first neuron, the input data signal value being stored at a second memory location in a second data structure portion that corresponds to a second value of the second pointer. The method further includes (c) weighting the input data signal value with the weighting value in order to generate a weighted input data signal value, which can be added with at least one other weighted input data signal value in calculating a result of the first neuron, and (d) incrementing the first and second values of the respective first and second pointers. The method additionally includes (e) repeating (a)-(d) to access successive weighting values stored at successive memory locations in the first data structure corresponding to successive values of the first pointer, to access successive input data signal values stored at successive memory locations in the second data structure corresponding to successive values of the second pointer, to weight the successive input data signal values with the successive weighting values in calculating the result of the first neuron, and to successively increment the first and second values.

### BRIEF DESCRIPTION OF THE DRAWINGS

FIG. 1 is a schematic diagram of a Prior Art neural network;

FIG. 2 is a schematic diagram of a new data structure that can be employed in the software implementation of the neural network of FIG. 1; and

FIG. 3 is a flow chart showing exemplary steps of a software routine for implementing the neural network of FIG. 1 utilizing the new data structure of FIG. 2.

### DETAILED DESCRIPTION OF THE INVENTION

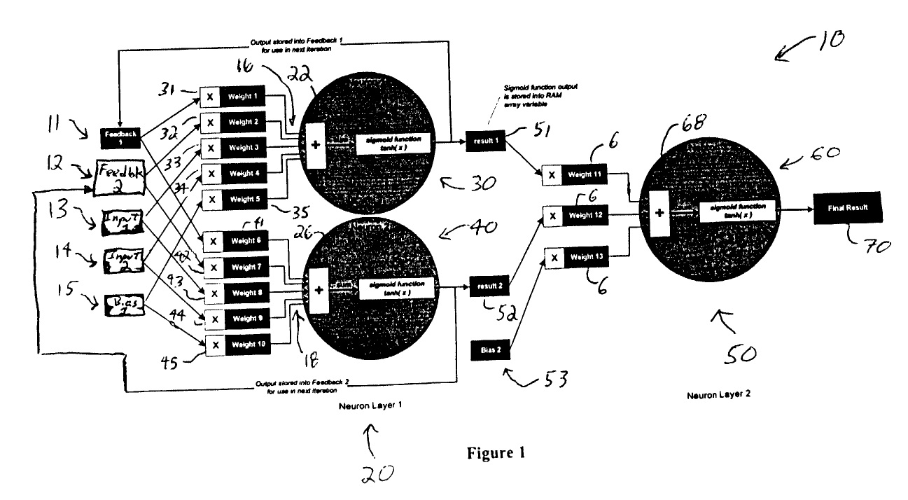

Referring to FIG. 1, a schematic diagram is provided showing elements of an exemplary neural network 10 that includes a first layer of neurons 20 with a first neuron 30 and a second neuron 40, and further includes a second layer of neurons 50 with a third neuron 60. The first and second neurons 30, 40 of the first layer 20 have respective summing junctions 22, 26, the outputs of which are provided to respective compressors or sigmoid functions 24, 28 (e.g., tanh(x)). The outputs of the respective sigmoid functions 24, 28 are the outputs or results 51, 52 of the first and second neurons 30, 40, respectively. Each of the neurons 30, 40 of the first layer of neurons 20 receives five sets of inputs, 16, 18, respectively. Each of the inputs is a respective input data signal that has been weighted by a respective weight value as discussed further below. The inputs of the respective sets of inputs 16, 18 are provided to the respective summing junctions 22, 26 of the respective neurons 30, 40 to be summed.

The input data signals that are weighted and then provided to each of the neurons 30, 40 include a first feedback signal 11, a second feedback signal 12, a first input signal 13, a second input signal 14, and a first bias signal 15. The first and second input signals 13, 14 can be provided from previous layers of the neural network 10 (that may or may not exist depending upon the embodiment), or can be provided from outside the neural network. The first and second feedback signals 11, 12 are equal to the prior values of the results 51, 52 of the first and second neurons 30, 40, respectively. Bias signals such as bias signal 15 can be provided from a variety of sources to influence operation of the neural network 10, and are often signals having a fixed value for the purpose of mitigating the influence of noise on the neural network.

With respect to the first neuron 30, the input data signals 11-15 are multiplied by (or otherwise weighted by) respective weighting values 31-35, and then the weighted input data signals are all provided as the set of inputs 16 to the summing junction 22, which sums the five weighted input data signals. With respect to the second neuron 40, the input data signals 11-15 are multiplied by other respective weight values 41-45, and the weighted input data signals are then provided as the set of inputs 18 to the summing junction 26, which sums the five weighted input data signals. Once the output from the summing junction 22 is compressed by the sigmoid function 24, the first neuron 30 produces the result 51. Likewise, once the output from the summing junction 26 is compressed by the sigmoid function 28, the second neuron 40 provides the result 52. The results 51, 52 are then fed back as the first feedback signal 11 and the second feedback signal 12, respectively. Thus, the neural network 10 is a recursive neural network, although the present invention also is applicable to other types of neural networks, such as feedforward neural networks.

The results 51, 52 are also provided as two input data signals to the second layer of neurons 50. As shown, the third neuron 60 of the second layer 50 receives three input data signals 51-53 that include both of the results 51, 52 and a second bias signal 53. The input data signals 51-53 are weighted by respective weight values 61-63 and, after being weighted by these weight values, are provided to a summing junction 68 that sums the three weighted input data signals. The output of the summing junction 68 is provided to another sigmoid function 69, the output of which is a final result 70 of the neural network 10.

Although the exemplary neural network 10 is shown to include only two layers of neurons 20, 50 having three neurons in total, and only includes five input data signals 11-15 to each of the neurons in the first layer of neurons and three input data signals 51-53 to the third neuron of the second layer of neurons, the neural network is meant to be exemplary of neural networks more generally having any number of layers of neurons, each of which could have any number of neurons and any number of input data signals provided to any of the neurons. Also, although the neural network 10 only includes two feedback signals 11, 12, two input signals 13, 14 and two bias signals 15, 53, the neural network is, again, intended to be exemplary of neural networks that have any number of feedback signals, input signals, or bias signals.

In order to complete the processing of the neural network 10, the final result 70 must be calculated. The computation used to arrive at the final result 70 begins with calculation of the respective results 51, 52 of the first and second neurons 30, 40 of the first layer 20. Processing takes on the form:

Result 51=tanh( (Feedback 1*Weight 1)+(Feedback 2*Weight 2)+(Input 1*Weight 3)+(Input 2*Weight 4)+(Bias 1*Weight 5)) (1)

Result 52=tanh( (Feedback 1*Weight 6)+(Feedback 2*Weight 7)+(Input 1*Weight 8)+(Input 2*Weight 9)+(Bias 1*Weight 10)) (2)

In equations (1) and (2), Feedback 1 is the value of the first feedback signal 11, Feedback 2 is the value of the second feedback signal 12, Input 1 is the value of the first input signal 13, Input 4 is the value of the second input signal 14, Bias 1 is the value of the first bias signal 15, Weights 1-5 correspond respectively to weight values 31-35, and Weights 6-10 correspond respectively to weight values 41-45. As discussed, the first feedback signal 11 (Feedback 1) is equal to the existing (previously calculated) value of the result 51, and the second feedback signal 12 (Feedback 2) is equal to the existing (previously calculated) value of the result 52. The final result 70 is then calculated based upon the first and second results 51, 52 as follows:

Final Result 70=tanh( (Result 51*Weight 11)+( Result 52*Weight 12)+(Bias 2*Weight 13)) (3)

In equation (3), Weights 11-13 correspond to weight values 61-63 and Bias 2 is the value of the second bias signal 53.

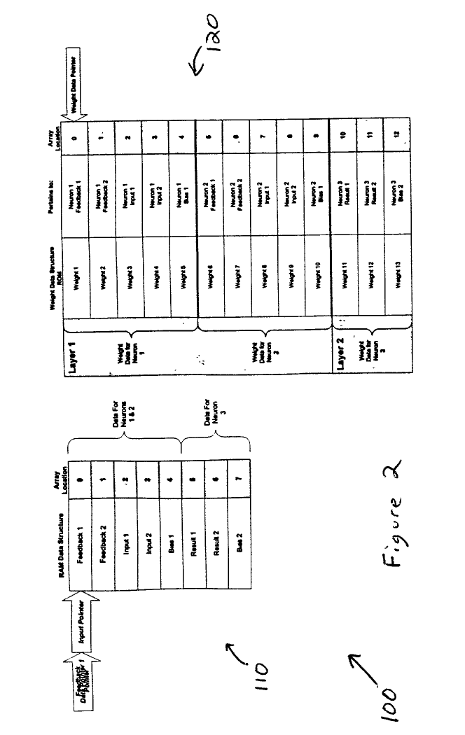

Given the above processing for calculating the final result 70 of the exemplary neural network 10, the present inventors have developed a new data structure 100 shown in FIG. 2 that allows for a reduction in the amount of memory needed to perform the processing of the neural network, and further allows for more rapid storing and retrieving of information to and from memory during the processing. As shown in FIG. 2, the new data structure 100 includes a first data structure portion 110 and a second data structure portion 120. The first data structure portion 110 typically exists in random access memory (RAM), while the second data structure portion 120 typically exists in read-only memory (ROM), although in alternate embodiments, the different data structure portions can exist in different types of memory (for example, the second data structure portion can exist in RAM as well). The first data structure portion 110 stores a single respective set of values of the input data signals for each layer of the neural network 10. Because all of the input data signals for each particular layer of the neural network are provided to each of the neurons in that layer, the values of each of the input data signals need only be stored once in the first data structure portion 110.

For example, as shown in FIG. 2, each of the five input data signals to the neurons 30, 40 of the first layer 20 of the neural network 10 are stored only once in the first data structure portion 110; namely, the first data structure portion includes array locations 0-4 that respectively correspond to the first feedback signal 11, the second feedback signal 12, the first input signal 13, the second input signal 14, and the first bias signal 15. Likewise, with respect to the second layer 50, each of the input data signals to the third neuron 60 is stored only once, that is, the result signals 51 and 52 and the second bias signal 53 are stored once in array locations 5-7.

Further as shown in FIG. 2, the second data structure portion 120 of the new data structure 100 includes array locations 0-12 corresponding to each of the weight values used by each of the neurons 30, 40 and 60 of each of the layers 20, 50 of the neural network 10. Specifically, the second data structure portion 120 includes array locations 0-4 for storing the weight values 31-35 for neuron 30, array locations 5-9 for storing the weight values 41-45 for neuron 40, and array locations 10-12 for storing the weight values 61-63 for neuron 60. The second data structure portion 120 stores the weight values 31-35, 41-45 and 61-63 sequentially in successive array (memory) locations. That is, the weight values for each given neuron in each layer are stored sequentially, the sets of array locations storing the sets of weight values for each of the neurons of each respective layer are ordered successively, and further, each of the groups of sets of array locations storing the weight values of neurons in different layers are ordered successively in order of the layers of the neural network 10. Because the weight values of each neuron corresponding to each particular input data signal (even if the neurons are in the same layer) often differ from one another, the second data structure portion 120 does not have single array locations that store weight values that are then used by multiple neurons. However, in certain alternate embodiments, where certain weight values are utilized by more than one neuron of possibly one or more layers, certain array locations can be used to store weight values corresponding to more than one neuron of one or more layers.

The new data structure 100 allows for the input data signals and weight values used to process the neural network 10 to be stored in a smaller amount of memory than conventional software systems. Because the various input data signals 11-15 and 51-53 are stored in sequential array (memory) locations in the same first data structure portion 110, and because the weights 31-35, 41-45, and 61-63 are stored in sequential array (memory) locations within the single second data structure portion 120, memory space located between or around the various input data signals or weight values is not wasted. Further, because the neurons of each layer of the neural network share the same input data signals, and because these input data signals for each particular layer are stored only once in the memory, memory space is saved in comparison with the amount of memory that would be used if each of the input data signals was stored repeatedly with respect to each individual neuron of a given layer having more than one neuron.

Additionally, the amount of time that it takes a computer running a software routine to store and retrieve the input data signal information and weight value information to and from the memory is reduced by way of the new data structure 100. Because of the sequential ordering in memory of the input data signals for each particular layer of neurons, the sequential ordering in memory of all the sets of input data signals in order of the layers of the neural network, and the sequential ordering in memory of all of the weight values used by all the neurons of the neural network, a software routine can incrementally proceed through the computer memory in order to obtain the successive amounts of data that are required to process the neural network 10. In particular, pointers (as discussed further below) can be efficiently used to refer to and access the data in memory, and the software programming code itself can be made more compact and efficient and be made to require less memory.

To summarize, therefore, the unique design/arrangement of stored data and weighting constants within the new data structure 100 allows for a more compact data structure to be used in processing neural networks, and thus requires less memory than conventional systems. The new data structure 100, because it allows for the efficient use of pointers and for the use of more compact and efficient software program code than is conventionally used, additionally allows for higher speeds of processing the neural networks. Thus, the new data structure 100 can provide higher throughput of signals and processing of neural networks than conventional systems even though it also requires less memory than conventional systems.

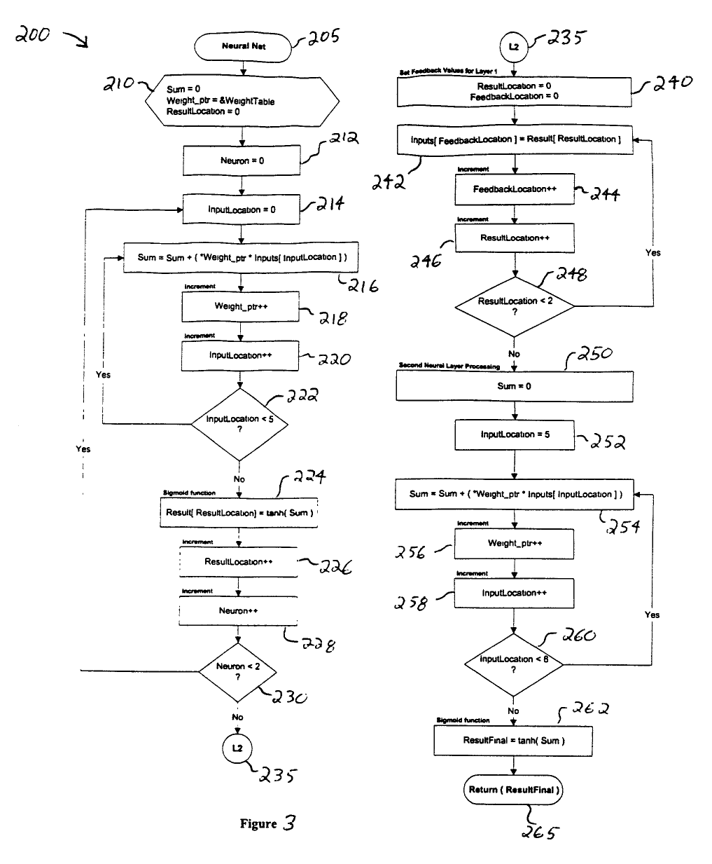

Steps of an exemplary software routine for processing the exemplary neural network 10 through the use of the new data structure 100 are shown in a flow chart 200 provided in FIG. 3. The steps of the flow chart 200 are particularly tailored for programming in the C computer language, although similar steps can be the basis for similar programs written in other languages. The first steps 210-230 concern calculation of the results 51, 52 of neurons 30, 40 of the first layer 20. Starting at step 205, two variables Sum and Result Location are initially set to 0, and a variable Weight_ptr is set to the initial addresses of the weight and variable data tables. The variable Sum is intended to represent the outputs of summing junctions 22, 26 prior to the compressing performed by the respective one of the sigmoid functions 24, 28, and the variable ResultLocation is representative of memory addresses corresponding to the results 51, 52. By setting Weight_ptr equal to &WeightTable, the pointer to the array locations of the weight values is set to the most recent array location. Next, at step 212, a variable Neuron is set to 0, where the variable Neuron indicates which of the neurons of the first layer 20 is currently being processed. In the embodiment shown, by setting Neuron equal to 0, the software routine begins by calculating the result 51 of the first neuron 30. At step 214, the variable InputLocation is also set equal to 0, where the variable InputLocation is indicative of a particular array location within the first data structure 110.

Next, at step 216, the variable Sum is calculated. The variable Sum keeps a running sum total of the weighted input data signals provided to the current neuron of interest. The variable Sum is calculated to equal the existing value of Sum plus a weighted input data signal. The weighted input data signal equals the product of the input data signal value stored at the array location currently specified by the variable InputLocation, multiplied by the weight value corresponding to that input data signal value, which is at the array location currently specified by the variable Weight_ptr. Then, at step 218, the value of the variable Weight_ptr is incremented and at step 220 the value of the variable InputLocation is incremented. At step 222, if the value of the variable InputLocation is 5 or greater following the incrementing of that variable at step 220, the software routine has completed calculation of the sum corresponding to the output of the summing junction of the current neuron, and the variable Sum includes all 5 weighted input data signals. If the value of the variable InputLocation is still less than 5, the subroutine returns to step 216 to further add to the value of the variable Sum the weighted input data signals corresponding to the additional remaining input data signals and corresponding weight values.

Once the software routine has proceeded past step 222 to step 224, a result corresponding to the current neuron is calculated and stored in memory. During the first execution of the steps 210-230, the result 51 is calculated to be equal to the hyperbolic tangent of the variable Sum. Next, at step 226, the variable ResultLocation is incremented and, at step 228, the variable Neuron is incremented. At step 230, it is then determined whether the variable Neuron, following its being incremented, is less than 2. If so, then steps 214-228 are repeated for the next neuron of the current layer (the first layer 20) of the neural network. In the present embodiment, where the exemplary neural network 10 includes two neurons 30, 40, steps 214-228 are performed twice in order to calculate the results 51, 52 corresponding to each of first and second neurons 30, 40. As noted, the new data structure 100 saves memory space insofar as only five array (memory) locations need to be occupied with data corresponding to the five input data signals 11-15, even though there are ten input data signals provided to the two neurons 30, 40 of the first layer 20 overall. That is, the software routine of FIG. 3 calculates each of the results 51,52 of each of the neurons 30, 40 of the first layer 20 using the same input information saved at the same array locations, for each neuron, repeatedly. Further, by incrementing the Weight ptr and InputLocation variables, the software routine accesses sequential memory addresses (array locations) and thereby saves time in the retrieving of information from memory.

The software subroutine then proceeds to step 235 at which it advances to a second level in which the first and second feedback signals 11, 12 are generated based upon the results 51, 52, and the final result 70 is calculated. As shown, in step 240, the variables ResultLocation and FeedbackLocation are both set equal to 0. Then, at step 242, an input data signal corresponding to the current value of the variable FeedbackLocation is set equal to the result corresponding to the present value of the variable ResultLocation. For example, in the first execution of the step 242, the first feedback signal 11 corresponding to a value of 0 for the variable FeedbackLocation is set equal to the result 51 corresponding to a value of 0 for the variable ResultLocation. The variables FeedbackLocation and ResultLocation are then incremented at steps 244 and 246 respectively. At step 248, the software subroutine determines whether the variable ResultLocation is less than two. If it is less than two, then the subroutine returns to step 242 and proceeds to set an additional input data signal (e.g., second feedback signal 121) equal to an additional result (e.g., result 52). For the exemplary neural network 10 shown in FIG. 1, there are only two neurons 30, 40 of the first layer 20 and therefore two results 51, 52, and consequently, the software subroutine only cycles through steps 242 through 246 two times in order to set the first and second feedback signals 11,12 equal to the results 51, 52 respectively.

Once all of the feedback signals 11,12 for the first layer 20 have been determined, the software subroutine then proceeds to process the second layer 50 of the neural network 10 to obtain the final result 70. Thus, at step 250, the variable Sum is set equal to zero, where the variable Sum is representative of the output of the summing junction 68. Next, at step 252, the variable InputLocation is set equal to 5 so that the subroutine begins at array location 5 of the first data structure portion 110 when it begins to calculate the weighted input data signals to be summed by the summing junction 68. Then, at step 254, the variable Sum is set equal to the existing value of the variable Sum plus an additional value equaling an additional weighted input data signal to be summed by the summing junction 68. As with respect to step 216, step 254 calculates the weighted input data signal as equal to the product of the value located at the array location indicated by the value of the variable Weight_ptr and the value of the input data signal located at the array location specified by the variable InputLocation. Because the value of the variable Weight_ptr is still equal to the value most recently determined following the incrementing of that variable at step 218, the variable Weight_ptr specifies array location 10 corresponding to the eleventh weight 62 as shown in the second data portion 120. Thus, during calculation of the second layer 50, the software subroutine continues to access sequential array locations in memory when obtaining the weight values to be used to process successive layers of the neural network 10.

At steps 256 and 258, respectively, the variables Weight_ptr and InputLocation are again incremented and at step 260, the software routine determines whether the current value of the variable InputLocation is still less than 8. If it is not still less than 8, this indicates that the software routine still has not completed the accessing of each of the array locations 5-7 of the first data structure portion 110 and calculated the weighted input data signals based upon each of the results 51, 52 and the second bias signal 53. Thus, the software routine cycles through steps 254-258 repeatedly until the variable InputLocation is equal to or greater than 8. Once the variable InputLocation is equal to or greater than 8, the software routine has completed the operation of summing junction 68 and the final result 70 can be calculated as equal to the hyperbolic tangent of the current value of the variable Sum, as shown in step 262. This final result 70 is returned by the subroutine to the main program being executed by the computer at step 265, at which point the subroutine is finished.

As already discussed, the steps of the flow chart 200 shown in FIG. 3 can be implemented in a program using the C programming language, particularly a program in which pointers are used. (An actual exemplary program in C for performing the processing of the exemplary neural network 10 is appended to the present patent application.) Alternatively, other programs using other computer languages, or even hardwired circuits, can be used to perform similar steps to those shown in FIG. 3. Although the steps of FIG. 3 are exemplary steps that correspond to the processing of the exemplary neural network 10 shown in FIG. 1 and using the exemplary new data structure 100 shown in FIG. 2, similar steps can be used in performing the processing of neural networks having more than two layers, neural networks having more than one or two neurons per layer, neural networks having layers in which there are more (or fewer) than five input data signals per neuron in a given layer, neural networks having more (or less) than two input signals or two feedback signals provided as input data signals to a given layer, or neural networks having more (or less) than two bias signals as input data signals.

Particularly in the case where there are more than two neurons in a given layer, the cycling through of steps such as steps 214-230 can be repeated more than twice corresponding to the actual number of neurons in the layer. Likewise, in neural networks different numbers of inputs to the neurons than the number of inputs provided in the neural network 10, the steps 216-222 or 254-260 can be repeated a different number of times than occurs in flow chart 200. Further, in neural networks having more (or less) than two feedback data signals used as input data signals to a given layer based on results of that layer, the steps 242-248 can be repeated more (or less) than twice. Additionally, neural networks having a different number of layers of neurons than the neural network 10 will have a different number of processing loops, namely, a fewer or greater number of processing loops than the first processing loop encompassing steps 210-248 corresponding to the first layer 20 and the second processing loop encompassing steps 250-262 corresponding to the second layer 50.

It will occur to those that practice the art that many modifications may be made without departing from the spirit and scope of the invention. In order to apprize the public of the various embodiments that may fall within the scope of the invention, the following claims are made:

What is claimed is:

1. In a memory device, a data structure for processing a neural network, the data structure comprising:
a first data structure portion within the memory device, the first data structure portion including a first plurality of sequential memory locations, wherein each of the first plurality of sequential memory locations stores a respective input data signal value to be provided to respective inputs of both a first neuron and a second neuron of a first layer of the neural network; and
a second data structure portion within the memory device, the second data structure portion including a second plurality of sequential memory locations, wherein each of the second plurality of sequential memory locations stores a respective weight value corresponding to a respective input of a respective one of the first neuron and the second neuron;
wherein the processing of the neural network includes sequentially retrieving the respective weight values corresponding to the respective inputs of the first neuron from the second plurality of sequential memory locations, sequentially retrieving each of the input data signal values corresponding to the respective inputs of the first neuron from the first plurality of sequential memory locations, and weighting each of the input data signal values with the corresponding respective weight value for the respective input of the first neuron, in order to calculate a first result of the first neuron; and
wherein the processing of the neural network further includes sequentially retrieving the respective weight values corresponding to the respective inputs of the second neuron from the second plurality of sequential memory locations, sequentially retrieving each of the input data signal values corresponding to the respective inputs of the second neuron from the first plurality of sequential memory locations, and weighting each of the input data signal values with the corresponding respective weight value for the respective input of the second neuron, in order to calculate a second result of the second neuron.

2. The data structure of claim 1, wherein the second data structure portion further includes a third plurality of sequential memory locations, wherein each of the third plurality of sequential memory locations stores a weight value corresponding to a respective input of a third neuron.

3. The data structure of claim 2, wherein the third neuron is included within the first layer of the neural network, and wherein the processing of the neural network includes sequentially retrieving the respective weight values corresponding to the respective inputs of the third neuron from the third plurality of sequential memory locations, sequentially retrieving each of the input data signal values from the first plurality of sequential memory locations, and weighting each of the input data signal values with a corresponding respective weight value from the third plurality of sequential memory locations, in order to calculate a third result of the third neuron.

4. The data structure of claim 2, wherein the third neuron is included within a second layer of the neural network, wherein the first data structure portion further includes a fourth plurality of sequential memory locations, and wherein each of the fourth plurality of sequential memory locations stores a respective input data signal value to be provided to a respective input of the third neuron.

5. The data structure of claim 4, wherein the processing of the neural network includes sequentially retrieving the respective weight values corresponding to the respective inputs of the third neuron from the third plurality of sequential memory locations, sequentially retrieving each of the input data signal values corresponding to the respective inputs of the fourth neuron from the fourth plurality of sequential memory locations, and weighting each of the input data signal values from the fourth plurality of sequential memory locations with the corresponding weight value from the third plurality of sequential memory locations for the respective input of the third neuron, in order to calculate a third result of the third neuron.

6. The data structure of claim 5, wherein the third result of the third neuron is a final result of the neural network, wherein the sequential retrieving of each of the input data signal values and the weight values is performed by way of at least one pointer, wherein the data structure allows for efficient use of memory, and wherein the data structure allows for a higher speed of processing the neural network than would a conventional system.

7. The data structure of claim 2, wherein the second data structure portion further includes a fourth plurality of sequential memory locations, wherein each of the fourth plurality of sequential memory locations stores a weight value corresponding to a respective input of a fourth neuron, wherein each of the third neuron and the fourth neuron are part of a second layer of the neural network.

8. The data structure of claim 7, wherein the first data structure portion further includes a fifth plurality of sequential memory locations, and wherein each of the fifth plurality of sequential memory locations stores a respective input data signal value to be provided to respective inputs of both the third neuron and the fourth neuron.

9. The data structure of claim 8, wherein the processing of the neural network includes sequentially retrieving the respective weight values corresponding to the respective inputs of the third neuron from the third plurality of sequential memory locations, sequentially retrieving each of the input data signal values corresponding to the respective inputs of the third neuron from the fifth plurality of sequential memory locations, and weighting each of those input data signal values from the fifth plurality of sequential memory locations with the corresponding weight value from the third plurality of sequential memory locations for the respective input of the third neuron, in order to calculate a third result of the third neuron, and
wherein the processing of the neural network includes sequentially retrieving the respective weight values corresponding to the respective inputs of the fourth neuron from the fourth plurality of sequential memory locations, sequentially retrieving each of the input data signal values corresponding to the respective inputs of the fourth neuron from the fifth plurality of sequential memory locations, and weighting each of those input data signal values from the fifth plurality of sequential memory locations with the corresponding weight value from the fourth plurality of sequential memory locations for the respective input of the fourth neuron, in order to calculate a fourth result of the fourth neuron.

10. The data structure of claim 1, wherein the memory device includes a random access memory (RAM) portion in which are located the first plurality of sequential memory locations of the first data structure portion.

11. The data structure of claim 1, wherein the memory device includes a readonly memory (ROM) portion in which are located the second plurality of sequential memory locations of the second data structure portion.

12. The data structure of claim 1, wherein the first result of the first neuron is fed back and stored within one of the second plurality of sequential memory locations as one the input data signal values, and wherein the second result of the first neuron is fed back and stored within another of the second plurality of sequential memory locations as another of the input data signal values.

13. The data structure of claim 1, wherein at least one of the input data signal values is a bias input, and at least one of the input data signal values is provided from outside the neural network.

14. The data structure of claim 1, wherein the weighting of the input data signal values with weight values occurs by multiplying the input data signal values with the weight values.

15. A neural net processing device comprising:
a first storage means for storing in a first set of sequential locations and a second set of sequential locations, respectively, a first set of weighting values that correspond to respective inputs of a first neuron, and a second set of weighting values that correspond to respective inputs of a second neuron;
a second storage means for storing in a third set of sequential locations a set of input data signal values corresponding to respective inputs of both the first neuron and the second neuron; and
a neural net processor that sequentially accesses pairs of input data signal values from the third set of sequential locations and corresponding weighting values from the first set of sequential locations for respective inputs of the first neuron, weights the input data signal values with the corresponding weighting values from the first set of sequential locations, and sums the weighted input data signal values in calculating a first result for the first neuron; and further sequentially accesses pairs of input data signal values from the third set of sequential locations and corresponding weighting values from the second set of sequential locations for respective inputs of the second neuron, weights the input data signal values with the corresponding weighting values from the second set of sequential locations, and sums the weighted input data signal values in calculating a second result for the first neuron.

16. A method of processing a neural network, the method comprising:
(a) accessing, through the use of a first pointer, a weighting value corresponding to an input of a first neuron of a first layer, the weighting value being stored at a first memory location in a first data structure portion that corresponds to a first value of the first pointer;
(b) accessing, through the use of a second pointer, an input data signal value corresponding to the input of the first neuron, the input data signal value being stored at a second memory location in a second data structure portion that corresponds to a second value of the second pointer;
(c) weighting the input data signal value with the weighting value in order to generate a weighted input data signal value, which can be added with at least one other weighted input data signal value in calculating a result of the first neuron;
(d) incrementing the first and second values of the respective first and second pointers; and
(e) repeating (a)-(d) to access successive weighting values stored at successive memory locations in the first data structure corresponding to successive values of the first pointer, to access successive input data signal values stored at successive memory locations in the second data structure corresponding to successive values of the second pointer, to weight the successive input data signal values with the successive weighting values in calculating the result of the first neuron, and to successively increment the first and second values.

17. The method of claim 16, wherein (d) further includes adding the weighted input data signal value to a running sum total.

18. The method of claim 17, further comprising:
(f) performing a compressing operation on a final value of the running sum total that is the sum of all of the weighted input data signals determined in the performing of (a)-(e), in order to obtain the result of the first neuron;
(g) storing the result in an additional memory location referenced by an a result pointer; and
(h) repeating (a)-(g) for successive neurons in the first layer, wherein the input data signal values accessed in (b) are repeatedly accessed for the successive neurons.

19. The method of claim 17, further comprising:
(f) performing a compressing operation on a final value of the running sum total that is the sum of all of the weighted input data signals determined in the performing of (a)-(e), in order to obtain the result of the first neuron; and
(g) storing the result in one of the memory locations of the second data structure as a feedback value that can be accessed as one of the input data signal values during a subsequent performance of (a)-(e).

20. The method of claim 16, further comprising:
(f) accessing, through the use of the first pointer, a weighting value corresponding to an input of a second neuron of a second layer, the weighting value being stored at a subsequent memory location in the first data structure portion that corresponds to a subsequent value of the first pointer, wherein the subsequent memory location is the memory location immediately following a last memory location storing a last weighting value corresponding to a last input of a last neuron of the first layer; and
(g) accessing, through the use of the second pointer, an input data signal value corresponding to the input of the second neuron, the input data signal value being stored at a succeeding memory location in the second data structure portion that corresponds to a succeeding value of the second pointer, wherein the succeeding memory location is the memory location immediately following a final memory location storing a final input data signal value corresponding to the last inputs of the neurons of the first layer.
